(19) United States
(12) Patent Application Publication
(10) Pub. No.: US 2022/0326672 A1
(43) Pub. Date: Oct. 13, 2022

(54) AUTOMATION FIELD DEVICE

(71) Applicant: Endress+Hauser SE+Co. KG, Maulburg (DE)

(72) Inventors: Simon Gerwig, Schopfheim (DE); Christian Strittmatter, Rickenbach (DE); Eric Bergmann, Steinen (DE)

(21) Appl. No.: 17/753,652

(22) PCT Filed: Aug. 20, 2020
(86) PCT No.: PCT/EP2020/073393

§ 371 Date: Mar. 10, 2022

(30) Foreign Application Priority Data
Sep. 13, 2019 (DE) 10 2019 124 704.7

(51) Int. Cl. G05B 19/042

(52) U.S. Cl. CPC G05B 19/042; G05B 2219/25011

(57) ABSTRACT

An automation field device includes a metal housing having a housing opening; an electronics having a first circuit board; arranged in the housing opening and leading into the housing interior, a cable connection having a plastic part, wherein a cable with an additional plastic part is connectable to the cable connection; and an antenna arranged on the first circuit board. The antenna is embodied for transmitting and receiving electromagnetic waves having a predetermined wavelength, and the antenna is oriented for transmitting electromagnetic waves in toward the housing opening and for receiving electromagnetic waves from the housing opening. The plastic parts are transmissive for the electromagnetic waves.

The invention relates to an automation field device.

In automation technology, especially in process automation technology, field devices are often applied, which serve for determining, monitoring, optimizing and/or influencing process variables, especially changeable process variables. Serving for registering process variables are sensors, which register process variables such as fill level, flow, pressure, temperature, and conductivity. Serving for influencing process variables are actuators, such as, for example, valves or pumps, via which the flow of a liquid in a pipeline section, or the fill level in a container, can be changed. Field devices often have a sensor unit, especially a sensor unit at least at times and/or at least sectionally in contact with a process medium. The sensor unit serves for producing a signal dependent on the process variable. Furthermore, field devices often have an electronics arranged in a housing, wherein the electronics serves for processing and/or forwarding signals produced by the sensor unit, especially electrical and/or electronic signals. Typically, the electronics includes at least one circuit board with components arranged thereon.

Referred to as field devices are, in principle, all devices, which are applied near to a process and which deliver, or process, process relevant information. In connection with the invention, the terminology, field devices, thus, refers also to remote I/Os (electrical interfaces), radio adapters, and, in general, devices, which are arranged at the field level. A large number of such field devices are produced and available from the applicant.

In modern industrial plants, field devices are, as a rule, connected with superordinated units via fieldbusses. Normally, the superordinated units are control systems, or control units, such as, for example, a PLC (programmable logic controller). The superordinated units serve, among other things, for process control, -visualizing, -monitoring as well as for commissioning of field devices. The process variables, or data, registered by field devices, especially their sensors, are transmitted via the connected fieldbus to one or, in given cases, more, superordinated units. In addition, also a data transmission from the superordinated unit via the bus system to the field devices is required; this can serve, for example, for diagnostic purposes. In general, the field device is serviced via the fieldbus from the superordinated unit.

Besides a data transmission by wire, in the case of such field devices, it must also increasingly be provided that data can be transmitted wirelessly. In such case, of concern is, for example, a wireless transmission of measured values and/or parametering data to the superordinated unit and/or to a mobile end device. The mobile end device is, for example, a smart phone, a tablet, a smart glasses, or a mobile end device specifically designed for process automation technology, such as, for example, the FieldXpert available from Endress+Hauser.

In order that a wireless data transmission can be implemented, the field devices must be equipped with a corresponding radio antenna, which is adapted for radiating and receiving electromagnetic waves.

The equipping of field devices with antennas has, however, the problem that field device housings are most often made of a conductive material, especially metal, which means that the electromagnetic waves are greatly attenuated or possibly even completely blocked. This leads, in turn, to the fact that the range of the radio signal for wireless data transmission with the field device is very small.

In order to achieve a greater range of the radio signal, in the state of the art in DE 10 2014 118 391 A1, a field device is provided, in the case of which electromagnetic waves transmitted from a primary antenna arranged within the field device are coupled to a first secondary antenna within the housing and then transmitted from the first secondary antenna to a second secondary antenna outside of the housing, in order so to be out-coupled by the second secondary antenna. The transmission from the housing interior to the housing exterior occurs, in such case, by means of guided waves, whose losses are lower than free waves. The secondary antennas are placed in an unused cable gland. Disadvantageous in the solution described in DE 10 2014 118 391 A1 is its complex construction, composed of a plurality of individual antennas, which must be matched to one another. Another disadvantage is that the cable gland with the secondary antennas integrated therein can no longer be used for the actually intended use of carrying a cable.

Additionally, especially in the case of a use of the field device in the food processing and/or pharmaceutical industries (“life sciences”), the associated hygienic standards often require a liquid tightly sealed housing. Such is, for example, assured in that the field device conforms to an IP protection type having a degree of protection of IP69K according to the standard, DIN EN 60529. In such case, the blind plug required in DE 10 2014 118 391 A1 for the secondary antennas is undesired, since, in given cases, sealing problems are caused thereby.

DE 10 2012 109 539 A1, in turn, discloses a coil arrangement, which is arranged in the interior of a housing of an automation field device in such a manner that a maximum transmission power through a housing opening is present. Disadvantageous in the solution published in DE 10 2012 109 539 A1 is, on the one hand, that the coil arrangement for transmitting from the housing opening must be arranged at a certain position in the interior of the housing, and, on the other hand, that the coil arrangement published therein is not integrateable into the electronics of the field device.

DE 10 2017 110 597 A1 discloses, in contrast, a solution, wherein an antenna is mounted with a flexible foil on a used, plastic, threaded, cable connection of a fedthrough cable. The antenna is, in turn, connected with the electronics of the field device by means of a coaxial cable, such that by means of the antenna a wireless communication capability is provided for the electronics. Disadvantageous in the solution published in DE 10 2017 110 597 A1 is that the therein described special adapting of the fedthrough cable is relatively cumbersome or in the above mentioned industries, in given cases, even undesirable. The latter is also true especially since preferably standard fedthrough cable are used.

An object of the invention, consequently, is to provide an easily manufacturable field device having an electronics with an antenna integrated therein.

The object is achieved by an automation field device, comprising:
a metal housing having a housing opening;
an electronics arranged in a housing interior and having at least one circuit board;
arranged in the housing opening and leading into the housing interior, a cable connection having a plastic part, wherein a cable with an additional plastic part is connectable to the cable connection; and
an antenna arranged on a first circuit board of the electronics,
wherein the antenna is embodied for transmitting and/or receiving electromagnetic waves having at least one predetermined wavelength
wherein the antenna is oriented in such a manner that it is embodied for transmitting electromagnetic waves in the direction of the housing opening and for receiving electromagnetic waves coming from the direction of the housing opening, and
wherein the plastic parts are transmissive for the electromagnetic waves, such that electromagnetic waves transmitted from the antenna are transmittable via the plastic parts out of the housing interior, and electromagnetic waves to be received by the antenna are transmittable via the plastic parts into the housing interior,

whereby by means of the antenna a wireless communication connection between the electronics and a transmitting/receiving unit arranged outside of the housing of the field device can be produced.

According to the invention, thus, an antenna integrated into the circuit board of the electronics is provided. The integration of the antenna into the electronics can occur very easily during manufacture of the electronics of the field device, for example, during the manufacturing and/or populating of the circuit board of the electronics.

The antenna is, in such case, embodied in such a manner that it is adapted for a predetermined frequency, or wavelength. Usual communication frequencies lie, for example, usually at 2.4 GHz (WLAN, Bluetooth, ANT). Thus, the antenna can, for example, as a result of corresponding antenna structures, be embodied in such a manner that such serves for transmitting data according to the Bluetooth standard IEEE 802.15 or a modified variant thereof, for example, Bluetooth LE (“Low Energy”).

By means of the antenna and the plastic parts transmissive for the transmitted/received electromagnetic waves (i.e. the plastic part of the cable connection and the other plastic part of a cable connected thereto), a wireless communication connection between the electronics and a corresponding (i.e. adapted to the predetermined wavelength) transmitting/receiving unit arranged outside of the housing of the field device can be established. The transmitting/receiving unit is, in such case, for example, part of an above mentioned mobile end device.

Because the plastic parts are used for passing the electromagnetic waves into the housing interior, or out of the housing interior, no other feedthrough and/or blind plug is required. This means that the housing can be embodied as an otherwise fully welded housing. Especially, it is, thus, a metal housing having exactly one housing opening, which is filled by the cable connection leading into the housing interior.

In a preferred embodiment of the field device, the antenna arranged on the first circuit board is integrated into the electronics, in that
it comprises a component soldered onto the first circuit board, and/or
it is formed by a conductive trace arranged on the first circuit board.

Thus, the antenna is integrateable into the electronics in the context of producing the circuit board (in case the antenna is formed by a conductive trace arranged on the first circuit board) and/or during manufacture of the electronics in the processing of the circuit board (in case the antenna comprises a component soldered onto the circuit board). The adding of the antenna in the production and/or processing of a circuit board means very little extra effort is involved. Thus, the field device is very easy to produce.

In an embodiment of the field device, via the cable connection a cable connected thereto is connected with the electronics, such that by means of the cable the electronics is suppliable with electrical energy and/or communication with the electronics can be conducted by wire. With reference to the communication by wire, the above described fieldbusses can be involved. Of course, the wired communication and/or energy supply can also occur via the cable of an analog measurement transmission path, for example, via a 4-20 mA measurement transmission path, to which the field device is connected, for example, via a 2 or 4-conductor cable.

In an additional development of the field device, the antenna is a monopole antenna, especially having a length of ¼ of the predetermined wavelength. Advantageously, it is, thus, an antenna without a coil.

In an embodiment of the field device, such includes a further component arranged on the first circuit board and having a signal production/evaluation unit, which is embodied for producing the electromagnetic waves transmitted from the antenna and for evaluating the electromagnetic waves received by the antenna. Advantageously thus, a signal production/evaluation unit is also integrated into the electronics of the circuit board.

In an especially preferred embodiment of the field device, the component comprising the antenna and/or the signal production/evaluating unit are/is embodied as an SMD component. Since an SMD component is soldered together with additional SMD components in a single reflow process, integrating the antenna into the electronics causes, in such case, no additional method steps in the production.

In an embodiment of the field device, the first circuit board with the signal production/evaluation unit and the antenna forms a module, which is arranged on a second circuit board of the electronics.

In an additional development of the field device, the component comprising the antenna and/or the conductive trace forming the antenna for transmitting and/or receiving the electromagnetic waves through the housing opening are/is arranged at essentially any predeterminable position on the first circuit board relative to the housing opening, or the module for transmitting and/or receiving the electromagnetic waves through the housing opening is arranged at essentially any predeterminable position on the second circuit board relative to the housing opening.

Advantageously within the scope of the invention, thus, the transmitting, receiving direction of the antenna is essentially determined only via its orientation. The antenna (the module) is, thus, arranged at any predeterminable position on the first circuit board (second circuit board). In contrast with the state of the art, there are relative to the receiving/sending direction advantageously no limitations as regards the arrangement of the antenna on the first (second) circuit board.

In an embodiment of the field device, the housing opening has a cable screw means for the cable, especially a cable screw means having a metric screw thread. By means of the cable screw means, the cable is connected to the cable connection.

Preferably, the field device is used in the above mentioned industries having increased hygiene requirements. For this, the following embodiments are relevant.

In an embodiment of the field device, the cable connection and the cable connected thereto by means of the cable screw means fills the housing opening essentially completely and seals such especially liquid tightly.

In an embodiment of the field device, the housing is, except for the housing opening completely filled by the cable connection and the cable connected thereto, an otherwise completely closed, especially fully welded, metal housing.

In an embodiment of the field device, the field device is embodied to conform to an IP protection type having a degree of protection of IP69K according to the standard, DIN EN 60529.

The invention will now be explained in greater detail based on the appended, schematic drawing, wherein equal reference characters refer to equal features. When perspicuity requires or it otherwise appears sensible, reference characters already shown in earlier figures are omitted in subsequent figures.

The figures of the drawing show as follows:

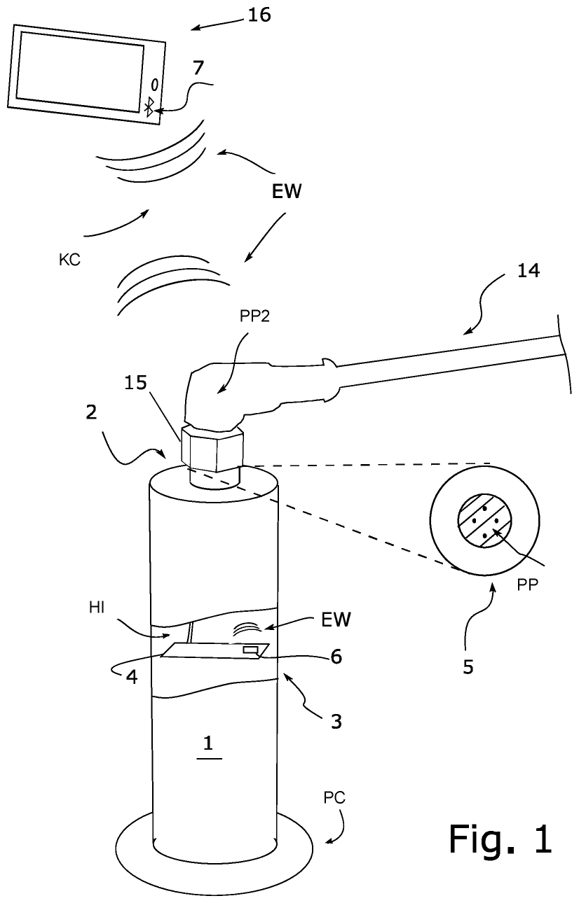

FIG. 1 a perspective view of an automation field device according to a first embodiment of the invention; and

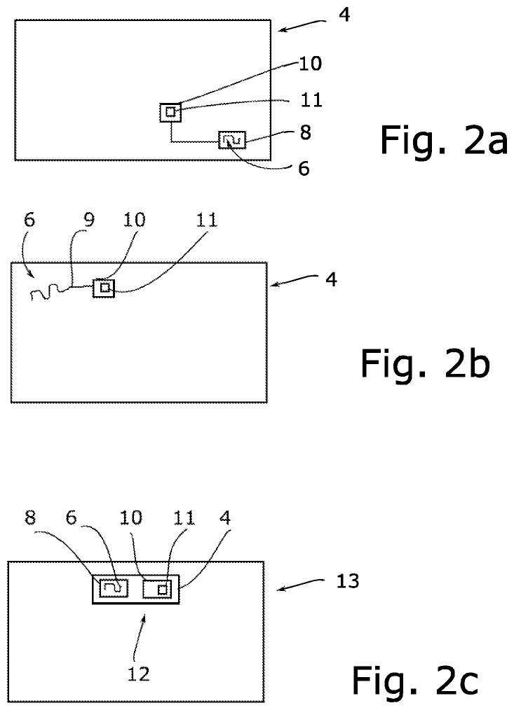

FIGS. 2a-2c plan views of various embodiments of the electronics of an automation field device of the invention.

FIG. 1 shows an automation field device for determining and/or monitoring a process variable of a medium according to a first embodiment of the invention having a fully welded, metal housing 1. The field device includes a sensor unit (not shown), which serves to produce a signal dependent on the process variable, and an electronics 3 arranged in a housing interior HI and having a first circuit board 4. Arranged In a housing opening 2 is a cable connection 5 leading into the housing interior HI. At an end section of the field device opposite the housing opening 2, the field device is connectable via a process connection PC with a pipe- and/or container wall, such that the sensor unit can interact with a medium arranged in the pipe or container for determining and/or monitoring the process variable of the medium.

The housing opening 2 includes in this embodiment supplementally a cable screw collar 15, having, in such case, a metric M12 screw thread, by means of which a cable 14 is connectable to the cable connection 5. The cable connection 5 (see dashed lines) is shown in detail in a plan view (from above, i.e. rotated relative to the perspective view by 90° about an axis extending horizontally in the plane of the paper). As the plan view of the detail shows, the cable connection 5 comprises an externally lying metal part, and an internal plastic part PP, in which the 4 conductors (black points) of the cable connection 5 are incorporated. The plastic part PP of the cable connection 5 is formed, for example, by an insulation of the cable connection 5.

The cable connection 5 is here an M12 plug, i.e. a standardized plug, to which a standardized cable 14 is connectable by means of the cable screw collar 15 having a metric screw thread of a certain diameter. Also the cable 14 connected to the cable connection 5 has an (additional) plastic part PP2.

Cable 14 connected with a first end section to the cable connection 5 is therewith connected with the electronics 3 arranged in the housing interior HI. Cable 14 serves for supplying the electronics 3, and thus the field device, with electrical energy and/or for wired communication with the electronics 3, and thus the field device. For this, the cable 14 is connected with a second end section opposite the first end section to a superordinated unit (not shown), for example, an above mentioned PLC, providing, in given cases, a power supply.

In order to be able also to produce a wireless communication connection KC with the field device, and its electronics 3, the electronics 3 includes an antenna 6. According to the invention, the antenna 6 is arranged on the first circuit board 4 of the electronics 3, wherein the antenna 6 is oriented in such a manner that it is embodied for transmitting electromagnetic waves EW in the direction of the housing opening 2, as well as for receiving from the direction of the housing opening 2 electromagnetic waves EW to be received. The transmitting and receiving direction is, thus, essentially determined based on the orientation of the antenna 6.

The electromagnetic waves EW representing the received-, or transmitted signal, as the case may be, can, in such case, be transmitted out, or transmitted in, as the case may be, through the plastic parts PP of the cable connection 5 and the M12 cable connection plug. Thus, advantageously, the fact is utilized that the M12 cable connection plug has in its interior the plastic part PP, through which the received-, or transmitted signal, as the case may be, can pass from a housing exterior into the housing interior HI, or from the housing interior HI to the housing exterior, as the case may be. The same situation holds for the cable 14 connected to the cable connection 5 and having the additional plastic part PP2. In this way, a wireless communication connection KC can be established between the electronics 3 and a corresponding transmitting/receiving unit 7.

The antenna is, in such case, adapted for a usual communication frequency, usually, at 2.4 GHz (WLAN, Bluetooth, ANT). By corresponding antenna structures, the antenna 6 is embodied in such a manner that such serves for transmitting data according to the Bluetooth standard IEEE 802.15 or a modified variant thereof, for example, Bluetooth LE (“Low Energy”).

Investigations of the applicant using a tablet as mobile end device 16 having a Bluetooth transmitting/receiving unit 7 show that with the field device of the invention a wireless communication connection KC between the electronics 3 and the transmitting/receiving unit 7 can be produced. A range of the radio signal extends at least 5 m, especially at least 10 m. This is found, in each case, for different lengths of the cable 14 connected to the cable connection 5.

FIGS. 2a to 2c show plan views of various embodiments of the first circuit board 4 and a second circuit board 13 of the electronics. The embodiments show mutually differing options of integrating the antenna 6 into the first circuit board of the electronics 3.

FIG. 2a shows the antenna 6 embodied as an SMD-solderable component 8, which is arranged on the first circuit board 4. Additionally arranged on the first circuit board 4 is a further component 10, which has the signal production/evaluation unit 11. The further component 10 is, thus, a highly integrated component (a so-called “system on a chip”), which provides the signal production and—evaluation of the electromagnetic waves EW having an above mentioned usual communication frequency, or wavelength, transmitted and received from and by the antenna 6. The further component 11 is advantageously also embodied as an SMD component.

FIG. 2b shows an embodiment similar to that shown in FIG. 2a, except that the antenna 6 shown in FIG. 2b is formed by means of a specially structured and directed, conductive trace 9.

As shown in FIG. 2c, in turn, the component 8 already shown in FIG. 2a with the antenna 6, the further component 10 with the signal production/evaluation unit 11 and the first circuit board 4 form a module 12. Module 12 is, in turn, arranged on a second circuit board 13 of the electronics 3.

In all cases, the antenna 6 is embodied as a monopole antenna, preferably a lambda/4 or quarter wavelength radiator. According to the invention, it is, in such case, advantageous that the transmit/receive direction of the antenna 6 is essentially independent of the positioning of the antenna 6 on the first circuit board 4 (FIGS. 2a;2b), or of the module 12 on the second circuit board 13 (FIG. 2c). The transmit/receive direction of the antenna 6 determined by the orientation of the component 8, the structured conductive trace 9 or the module 12 is predetermined, in such case, according to the invention, (for the case, in which the first circuit board 4, or the second circuit board 13 is installed in the housing 1 in a predetermined installed position) by pointing the transmit/receive direction in the direction of the housing opening 2 (i.e. toward the cable connection 5 arranged therein and having the plastic part PP).

The invention is especially advantageous for a housing 1, which is fully welded except for housing opening 2 and which is, for example, embodied to conform to an IP protection type having a degree of protection of IP69K according to the standard, DIN EN 60529. By means of the solution of the invention, also in this case a wireless communication connection KC between the electronics 3 and a corresponding transmitting/receiving unit 7 can be established (i.e., a wireless communication connection KC embodied for receiving/transmitting electromagnetic waves EW of the aforementioned wavelength).

### REFERENCE CHARACTERS AND SYMBOLS

| | |
|---|---|
| 1 | housing |
| 2 | housing opening |
| 3 | electronics |
| 4 | first circuit board |
| 5 | cable connection |
| 6 | antenna |
| 7 | transmitting/receiving unit |
| 8 | component |
| 9 | conductive trace |
| 10 | further component |
| 11 | signal production/evaluation unit |
| 12 | module |
| 13 | second circuit board |
| 14 | cable |
| 15 | cable screw collar |
| 16 | mobile end device |
| HI | housing interior |
| PP, PP2 | plastic part, other plastic part |
| EW | electromagnetic waves |
| KC | wireless communication connection |
| PC | process connection |

1-12. (canceled)

13. An automation field device, comprising:
a metal housing having a housing opening;
an electronics arranged in a housing interior and having a first circuit board;
arranged in the housing opening and leading into the housing interior, a cable connection having a plastic part, wherein a cable with an additional plastic part is connectable to the cable connection; and
an antenna arranged on the first circuit board of the electronics,
wherein the antenna is embodied for transmitting and receiving electromagnetic waves having a predetermined wavelength,
wherein the antenna is oriented for transmitting the electromagnetic waves toward the housing opening and for receiving the electromagnetic waves coming from the housing opening, and
wherein the plastic parts are transmissive for the electromagnetic waves, such that electromagnetic waves transmitted from the antenna are transmittable via the plastic parts out of the housing interior, and electromagnetic waves to be received by the antenna are transmittable via the plastic parts into the housing interior, and
wherein via the antenna a wireless communication connection between the electronics and a transmitting/receiving unit outside of the housing of the field device can be produced.

14. The automation field device as claimed in claim 13,
wherein the antenna arranged on the first circuit board is integrated into the electronics, and
wherein the antenna includes a component soldered onto the first circuit board and/or the antenna is formed by a conductive trace arranged on the first circuit board.

15. The automation field device as claimed in claim 13,
wherein via the cable connection a cable connected thereto is connected with the electronics such that via the cable the electronics is suppliable with electrical energy and/or communication with the electronics can be conducted by wire.

16. The automation field device as claimed in claim 13,
wherein the antenna is a monopole antenna having a length of ¼ of the predetermined wavelength of the electromagnetic waves.

17. The automation field device as claimed in claim 14, further comprising:
a further component arranged on the first circuit board and having a signal production/evaluation unit embodied for producing electromagnetic waves transmitted from the antenna and for evaluating electromagnetic waves received from the antenna.

18. The automation field device as claimed in claim 17, wherein the component including the antenna and/or the signal production/evaluating unit is embodied as a surface mounted devices (SMD) component.

19. The automation field device as claimed in claim 17,
wherein the electronics further includes a second circuit board, and
wherein the first circuit board with the signal production/evaluation unit and the antenna form a module which is arranged on the second circuit board.

20. The automation field device as claimed in claim 19,
wherein the component comprising the antenna and/or the conductive trace forming the antenna for transmitting and/or receiving the electromagnetic waves through the housing opening are/is arranged at any predeterminable position on the first circuit board relative to the housing opening, or
wherein the module for transmitting and/or receiving the electromagnetic waves through the housing opening is arranged at any predeterminable position on the second circuit board relative to the housing opening.

21. The automation field device as claimed in claim 13,
wherein the housing opening has a cable screw means for the cable.

22. The automation field device as claimed in claim 21,
wherein the cable connection and the cable connected thereto by the cable screw means fills the housing opening completely and seals the housing opening liquid tightly.

23. The automation field device as claimed in claim 13,
wherein the housing is, except for the housing opening completely filled by the cable connection and the cable connected thereto, an otherwise completely closed, fully welded, metal housing.

24. The automation field device as claimed in claim 13,
wherein the field device is embodied to conform to an IP protection type having a degree of protection of IP69K according to the standard, DIN EN 60529.
